(19) United States
(12) Patent Application Publication
(10) Pub. No.: US 2011/0164040 A1
(43) Pub. Date: Jul. 7, 2011

(54) METHOD FOR DEPICTING A STATE

(75) Inventors: Klaus Vaehsen, Duesseldorf (DE); Jens Wellhausen, Aachen (DE)

(73) Assignee: SCHAEFFLER TECHNOLOGIES GMBH & CO. KG, Herzogenaurach (DE)

(21) Appl. No.: 12/999,711

(22) PCT Filed: Jun. 17, 2009
(86) PCT No.: PCT/DE09/00832

§ 371 Date: Mar. 16, 2011

(30) Foreign Application Priority Data
Jun. 20, 2008 (DE) 10 2008 029 484.5

(51) Int. Cl. G06T 11/20

(52) U.S. Cl. 345/440

(57) ABSTRACT

A method for representing a state of at least one component of a device. In this case, at least one characteristic value is determined for the at least one component and is represented in a globe diagram for the purpose of representing the state. The globe diagram permits the representation of different hierarchical levels of a state visualization. Additionally, an arrangement for representing a state of at least one component of a device, a computer program and a computer program product is disclosed.

### FIELD OF THE INVENTION

The invention relates to a method for representing a state of at least one component of a device, an arrangement for representing a state of at least one component of a device, a computer program and a computer program product.

### BACKGROUND OF THE INVENTION

An assessment of a state of devices, i.e. of machines and/or installations, is usually based on the analysis of the temporal development of a wide variety of measurement and/or characteristic variables. A visualization technique that can be used to implement two different aims simultaneously is of interest here. On the one hand, it is desirable to register the overall state and/or the trend and hence a temporal development of the overall state of a device at a glance and without background knowledge. At the same time, however, there is also interest in enabling a clear and nevertheless more detailed observation of the state and trends of individual assemblies and hence of components of the device through to the visualization of different characteristic values of an assembly, in order, in the case of damage, to be able to read comprehensive information about the damage.

### SUMMARY OF THE INVENTION

The invention relates to a method for representing a state of at least one component of a device. In this case, it is provided that at least one characteristic value is determined for the at least one component and is represented in a globe diagram for the purpose of representing the state.

Accordingly, the state of the corresponding component of the device is represented by the representation of the characteristic value in the globe diagram as provided in the context of the invention. The globe diagram has, like a map of the world, for example, a coordinate system spanned from degrees of longitude and degrees of latitude. The globe diagram permits the representation of different hierarchical levels of a state visualization.

The device usually has a plurality of components, wherein some components can form an assembly of the device. The state of a component is characterized by the at least one characteristic value or at least one measurement value. The at least one characteristic value or measurement value can be determined and hence registered during the operation of the device by measurement of at least one generally physical variable of the at least one component. In this case, it is also possible to determine a plurality of characteristic values for one component at one point in time. These characteristic values can be based on different physical variables that are measured possibly vectorially in different spatial directions.

Usually, the at least one characteristic value for the at least one component is assigned to a degree of longitude of the globe diagram. Furthermore, the state of the at least one component is represented by a position of the at least one characteristic value assigned to the at least one component in the direction of the degrees of latitude of the globe diagram.

The globe diagram provided for the implementation of the invention can also be embodied as in the case of a typical representation of a map of the world with degrees of longitude and latitude. Thus, one possible variant provides for the globe diagram to be bounded by two poles, usually a north pole and a south pole, wherein the degrees of longitude intersect at the two poles. In one possible embodiment of the globe diagram, the degrees of latitude are arranged parallel to one another, wherein the degrees of longitude intersect generally perpendicularly a degree of latitude embodied as an equator. Furthermore, the globe diagram is bounded by two outer degrees of longitude.

A trend and hence a temporal development for the state can be represented by an ellipse assigned to the at least one characteristic value. This measure makes it possible to represent a current state of the at least one component by the position of the characteristic value within the globe diagram and at the same time to indicate a change in the state with the ellipse assigned to the characteristic value likewise within the globe diagram.

In this case, the development of the average value and of the variance of the at least one characteristic value over a time period that is to be defined and reaches back into the past is formed and displayed as an ellipse around the current characteristic value. It is thus possible to represent changes or trends of a respective characteristic value in the globe diagram. Moreover, a plurality of characteristic values can be represented in a hierarchical form that reflects a construction of the device. With the globe diagram, at least one characteristic value and hence a corresponding state can be monitored for the at least one component of the device. In one configuration, hierarchical levels of the device can be represented by a plurality of characteristic values and/or corresponding ellipses depicted in the globe diagram, such that a refined analysis of the corresponding state can be carried out.

In one case, it is possible for degrees of longitude of the globe diagram to be combined by means of a weighting, such that a plurality of weighted characteristic values, e.g. for a component, are represented in a manner combined on one degree of longitude.

In order to evaluate a state of the at least one component, a position of the at least one characteristic value on the globe diagram can be taken into account.

In order to provide a characteristic value or measurement value, an oscillation of the at least one component can be measured as a physical variable, e.g. by means of an oscillation or sound measurement.

The invention furthermore relates to an arrangement for representing a state of at least one component of a device. In this case, this arrangement has at least one measuring unit designed to determine and hence provide at least one characteristic value or measurement value for the at least one component. In addition, the arrangement has at least one display unit designed to represent the at least one characteristic value in a globe diagram for the purpose of representing the state.

In a further configuration, the arrangement has at least one computing unit designed to provide the at least one characteristic value for the purpose of representation in the globe diagram. In this case, a position of the correspondingly assigned characteristic value within the globe diagram is calculated by the computing unit for the purpose of the representative representation of the state of the respective component. In addition, the computing unit can calculate an ellipse provided for representing a change in the state of the respective component, as described above.

The arrangement described is designed to carry out all the steps of the method described above. In this case, individual steps of this method can also be carried out by individual units or modules of the arrangement. Furthermore, functions of the arrangement or functions of individual units or modules of the arrangement can be implemented as steps of the method.

The invention furthermore relates to a computer program comprising program code means for carrying out all the steps of a method described if the computer program is executed on a computer or a corresponding computing unit, in particular in an arrangement according to the invention.

The computer program product according to the invention comprising program code means stored on a computer-readable data carrier is designed for carrying out all the steps of a method described if the computer program is executed on a computer or a corresponding computing unit, in particular in an arrangement according to the invention.

The invention therefore relates, inter alia, to a method for the clear representation of multi- or high-dimensional feature vectors in the diagnostics of devices, which can be embodied e.g. as machines. Such feature vectors are represented by the characteristic values described above. This comprises a general evaluation and/or representation of characteristic or measurement values, e.g. of state measurements on machines and components, which can be embodied as rolling bearings, by means of an oscillation analysis. A clear representation of a multiplicity of characteristic values or measurement values and their temporal trends or changes for the purpose of simple state detection of complex devices or systems is provided in the context of the invention. In this case, the representation can provide a rapid overall overview of the state. Furthermore, it is possible also to analyze individual characteristic or measurement values in detail.

The invention comprises the introduction of a so-called globe diagram. The latter makes it possible to represent a multiplicity of characteristic values or measurement values and the temporal trends thereof. In this case, a hierarchical level is defined by the number of characteristic values represented in the globe diagrams. In a highest hierarchical level, only one characteristic value is represented for just one component. Refinements of the hierarchical levels are produced by means of a larger number of characteristic values within the globe diagram. In this case, it is possible to represent a respective characteristic value for a plurality of components and/or a plurality of characteristic values for at least one component. The more characteristic values are taken into account, the more finely or more accurately a state of a device formed from components can be represented. This hierarchical form reflects the construction of a device, inter alia. Accordingly, the device can have two hearings, for example, as components, wherein a plurality of characteristic values can be monitored for each bearing.

The exemplary embodiment of the method as described below relates to a visualization technique used to represent characteristic values as high-dimensional feature vectors in a hierarchy that can be registered in a simple manner for the user. One aspect of the invention comprises plotting a multiplicity of individual characteristic values in a diagram similar to a map of the world, the so-called globe diagram, such that each degree of longitude of the globe diagram is assigned to a characteristic value. The region around the north pole of the globe diagram is defined as an entirely satisfactory state in this representation. By contrast, the region of the south pole represents advanced damage. The equator zone of the globe diagram can represent the region of incipient damage. The characteristic values are very close together in the region of the poles of the globe diagram. By contrast, they are at greater distance from one another in the region of the equator. This representation allows a more differentiated observation of the characteristic values in the region of the equator, such that a first assessment is provided by means of this representation for the user. If all the characteristic values are arranged in the region of the north pole, i.e. the entirely satisfactory region, a close inspection of individual characteristic values by the user is not necessary. A change in individual characteristic values in the direction of the equator with the higher resolution present there can encourage a critical observation of individual characteristic values.

In order to visualize not only an instantaneous state but also the trend or the tendency of development of a state, the average value and the variance of a respective state over a time period to be defined into the past are formed and displayed as an ellipse around the current state. This makes it clear whether the current state of the at least one component of the device is stable, which is represented e.g. by a small ellipse, or whether the state is subject to a change, which is represented by a large ellipse, the midpoint of which is possibly not arranged in the vicinity of the current characteristic value.

A clearer, less detailed view can be produced by combining degrees of longitude within the globe diagram with suitable weighting. In the area of diagnosis of devices embodied as machines, e.g. the characteristic values concerning a specific bearing as a component are combined. A superordinate degree of longitude describing the overall state of the relevant bearing is thus provided. This combination can likewise be carried out correspondingly for all the other components or parts of the device or machine which are to be monitored. The resultant degrees of longitude can in turn be combined with suitable weighting, such that an individual degree of longitude can stand for an ever greater number of components and/or characteristic values depending on the hierarchical level. The termination of the grouping is formed by an individual line at the highest level, on which the current state or the trend of the state of a complete device, e.g. machine, is displayed. The number of intermediate levels or hierarchical levels is as desired.

A further aspect of this method comprises the simultaneous display of different hierarchical levels. In the case of a large number of characteristic or measurement values or characteristic or measurement value groups, it is expedient, for example, to display the refinement of the representation only for one degree of longitude, while the remaining degrees of longitude display superordinate hierarchical levels.

The method is suitable not just for the representation of machine states. Typically, it can be employed wherever high-dimensional feature vectors are intended to be visualized and an expedient hierarchical grouping of the individual components by means of the characteristic values is possible. Furthermore, in one configuration, a feature vector can define and/or represent a combination of a multiplicity of different characteristic values to form a vector.

Further advantages and configurations of the invention will become apparent from the description and the accompanying drawing.

It goes without saying that the features mentioned above and those yet to be explained below can be used not only in the combination respectively indicated, but also in other combinations or by themselves, without departing from the scope of the present invention.

### BRIEF DESCRIPTION OF THE DRAWINGS

FIG. 1 shows the schematic illustration of a first embodiment of a globe diagram provided in the context of the invention.

FIG. 2 shows a second embodiment of a globe diagram provided in the context of the invention, in a schematic illustration.

FIG. 3 shows a third embodiment of a globe diagram provided in the context of the invention, in a schematic illustration.

FIG. 4 shows an embodiment of an arrangement according to the invention in a schematic illustration.

The invention is illustrated schematically on the basis of embodiments in the drawings and is described comprehensively below with reference to the drawings.

The figures are described cohesively and in an overarching manner; identical symbols designate identical objects.

### DETAILED DESCRIPTION OF THE DRAWINGS

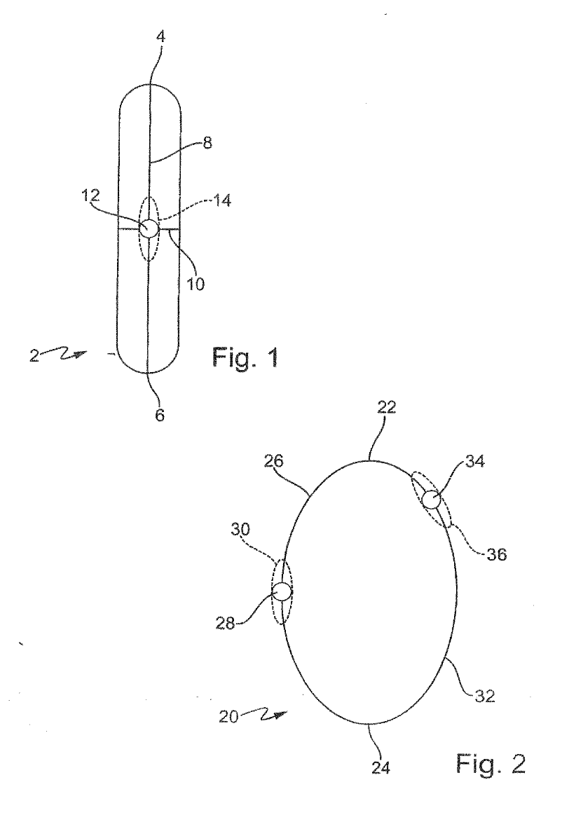

FIG. 1 shows the schematic illustration of a first embodiment of a globe diagram 2. Said globe diagram 2 comprises a north pole as first pole 4 and a south pole as second pole 6. A first degree of longitude 8 is illustrated in the center in the globe diagram 2. Furthermore, the representation of the first globe diagram 2 from FIG. 1 comprises a first degree of latitude 10, which is embodied here as an equator of the globe diagram 2. Along the first degree of longitude 8, a first characteristic value 12 is represented by a point in the region of the first degree of latitude 10. Said characteristic value 12 is furthermore assigned an ellipse 14, which represents a trend or a development of the characteristic value 12.

In the context of the method it is provided that, for the representation of a state of at least one component of a device, a number of characteristic values are registered for the at least one component by the measurement of at least one physical variable. For the representation of the state of the at least one component, in the present example the characteristic value 12 is represented for the number of characteristic values in the globe diagram 2.

In this case, it is furthermore provided that the characteristic value 12 is assigned to the first degree of longitude 8. In this case, the characteristic value 12 can assume different positions along the first degree of longitude 8 in the direction of the degrees of latitude 10. The state of the at least one component is qualitatively and therefore representatively represented by the position of the characteristic value 12 in the direction of the degrees of latitude 10.

FIG. 1 visualizes the state of the at least one component at a highest hierarchical level. The characteristic value 12, which represents the state here, is arranged for example in a critical region. A variance of the state is delimited by the ellipse 14.

On the first degree of longitude 8 and hence on an axis, the overall state of a device embodied as a machine is represented by the point for the characteristic value 12. The temporal trend of the state is represented by the dashed ellipse 14, reflecting the average value and variance of a change of the state. A weighting of the individual components of the high-dimensional state vector in the summation is usually dependent on prior knowledge about the machine to be assessed.

FIG. 2 shows, in a schematic illustration, a second embodiment of a globe diagram 20 provided in the context of a variant of the method according to the invention.

This second globe diagram 20, too, comprises a north pole 22 as a first pole and a south pole 24 as a second pole. Along a first outer degree of longitude 26 (left), a first characteristic value 28 is represented as a point. In this case, said characteristic value 28 is furthermore assigned an ellipse 30. Along a second degree of longitude 32 (right), a second characteristic value 34 represented here as a point is arranged within the globe diagram 20. Said characteristic value 34 is likewise assigned an ellipse 36.

With the embodiment of the globe diagram 20 as shown in FIG. 2, a respective state of two components of a device is represented by the two characteristic values 28, 34 and also by the assigned ellipses 30, 36. In the context of the method, a number of characteristic values are measured for each of these two components. A state of a first component is represented by the first characteristic value 28 assigned to said first component, here by the position of said first characteristic value along the first degree of longitude 26. A variance and hence a change of the state of the first component of the device is furthermore represented by the first ellipse 30. The second characteristic value 34 is assigned to a state of a second component of the device, wherein a state of the second component is represented by a position of the second characteristic value 34 along the second degree of longitude 32. A change in the state is represented by the second ellipse 36, which is assigned to the second characteristic value 34.

The second globe diagram 20 from FIG. 2 represents a first refinement level of the first globe diagram 2 from FIG. 1 if the device embodied as a machine contains, for example, two components to be monitored, which are embodied as rolling bearings, for example.

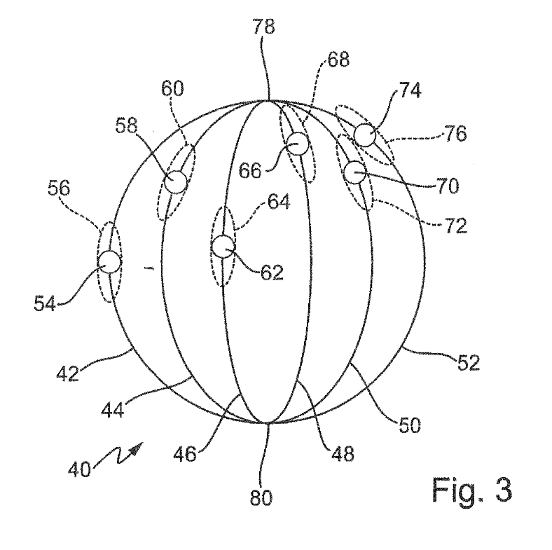

The third embodiment—illustrated in FIG. 3—of a globe diagram 40 provided in the context of an implementation of the method according to the invention comprises six degrees of longitude 42, 44, 46, 48, 50, 52. Respective states of a total of two components of a device are represented with this third embodiment of the globe diagram 40.

In this case, for a state of a first component it holds true that this state is represented by a first characteristic value 54, which is arranged along the first degree of longitude 42 and illustrated by a point, a second characteristic value 58, which is arranged within the globe diagram 40 along the second degree of longitude 44, and a third characteristic value 62, which is represented in the form of a point along the third degree of longitude 46. A variance of a respective characteristic value 54, 58, 62 is represented by an ellipse 56, 60, 64 assigned to the respective characteristic value 54, 58, 63.

A state of a second component is represented by a fourth characteristic value 66 along the fourth degree of longitude 48, a fifth characteristic value 70 on the fifth degree of longitude 50, and a sixth characteristic value 74 arranged along the sixth degree of longitude 52. Variances of these characteristic values 66, 70, 74 mentioned are illustrated by the assigned ellipses 68, 72, 76.

The third globe diagram 40 furthermore comprises a pole 78 embodied as a north pole and also a pole 80 embodied as a south pole. The degrees of longitude 42, 44, 46, 48, 50, 52 represented intersect at these two poles 78, 80. A qualitative and/or quantitative statement about the states of the two components can be made in the context of the method on the basis of a position at which a respective characteristic value 54, 58, 62, 66, 70, 74 is arranged along the degrees of longitude 42, 44, 46, 48, 50, 52. For the present embodiment it holds true that characteristic values 66, 70, 74 of the second component are arranged in the vicinity of the north pole 78 and are therefore classified as non-critical. This simultaneously means that the state of the first component, which is represented by the characteristic values 66, 70, 74 in the globe diagram 40, can be classified as non-critical.

A state represented by a characteristic value 54, 58, 62, 66, 70, 74 is to be classified as more critical, the closer the respective characteristic value 54, 58, 62, 66, 70, 74 is positioned in the direction of the second pole 80 and hence of the south pole. This is the case here for the characteristic values 54, 58, 62 and the state of the first component as represented thereby.

In addition, the third globe diagram from FIG. 3 shows a further refinement level of the two globe diagrams 2, 20 from FIGS. 1 and 2 if two components embodied as rolling bearings in each case are monitored for example with three characteristic values 54, 58, 62, 66, 70, 74 in each case. A detailed diagnosis of the cause of a critical state and hence also overall state is possible at this level.

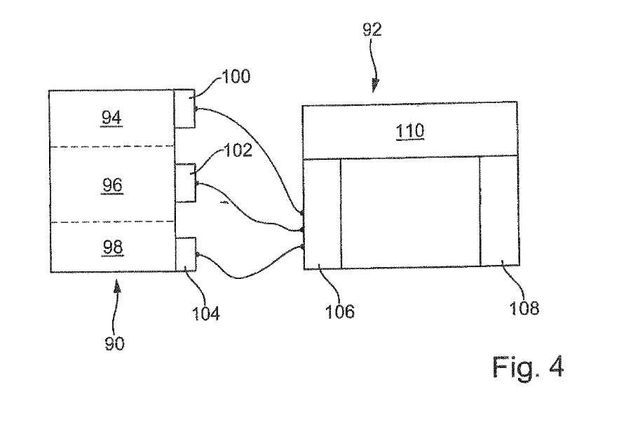

FIG. 4 shows a device 90 and an embodiment of an arrangement 92 according to the invention in a schematic illustration. In this case, it is provided that the device has a first component 94, a second component 96 and a third component 98.

In the present embodiment, the arrangement 92 has three measuring modules 100, 102, 104 embodied as sensors. In addition, the arrangement 92 comprises a detection module 106, a computing unit 108 and also a display unit 110.

For an implementation of the method according to the invention it is provided that a first measuring module 100 is assigned to a first component 94 of the device 90, a second measuring module 102 is assigned to a second component 96, and a third measuring module 104 is assigned to a third component 98. Variables of the components 94, 96, 98 are measured by the measuring modules 100, 102, 104. In the present embodiment, characteristic or measurement values with regard to the measured variables are communicated to the detection module 106 in a wired fashion. By means of the computing unit 108, the characteristic values with regard to the variables are processed further and conditioned to form a graphical representation. The graphically conditioned characteristic values are represented by means of the display unit 110 of the arrangement 92 in the form of globe diagrams 2, 20, 40 such as have already been presented in FIGS. 1 to 3.

1-12. (canceled)

13. A method for representing a state of at least one component of a device, comprising the steps of:
determining at least one characteristic value for the at least one component; and
representing the at least one characteristic value in a globe diagram to represent the state of the at least one component.

14. The method according to claim 13, wherein the at least one characteristic value is assigned to a degree of longitude of the globe diagram.

15. The method according to claim 13, wherein the state of the at least one component is represented by a position of the at least one characteristic value assigned to the at least one component in a direction of degrees of latitude of the globe diagram.

16. The method according to claim 13, wherein a trend for the state of the at least one component is represented by an ellipse assigned to the at least one characteristic value.

17. The method according to claim 16, wherein the ellipse is formed in a manner dependent on a development of an average value of the at least one characteristic value.

18. The method according to claim 13, wherein hierarchical levels of the device are represented by a number of the characteristic values depicted in the globe diagram for the at least one component.

19. The method according to claim 13, wherein degrees of longitude of the globe diagram are combined by means of a weighting.

20. The method according to claim 13, wherein an oscillation of the at least one component is measured to determine the at least one characteristic value.

21. An arrangement for representing a state for at least one component of a device, comprising:
at least one measuring unit determining at least one characteristic value for the at least one component; and
at least one display unit representing the at least one characteristic value in a globe diagram representing the state of the at least one component.

22. The arrangement according to claim 21, further comprising at least one computing unit which provides the at least one characteristic value for the purpose of representation in the globe diagram.

23. A computer program, comprising:
program code means carrying out the steps of a method for representing a state of at least one component of a device, the method comprising the steps of determining at least one characteristic value for the at least one component; and representing the at least one characteristic value in a globe diagram to represent the state of the at least one component when the computer program is executed on a computer or a corresponding computing unit in an arrangement for representing a state for at least one component of a device, comprising at least one measuring unit determining at least one characteristic value for the at least one component; and at least one display unit representing the at least one characteristic value in a globe diagram representing the state of the at least one component.

24. A computer program product, comprising:
a program code means stored on a computer-readable data carrier, the program code means carry out the steps of a method for representing a state of at least one component of a device, the method comprising the steps of determining at least one characteristic value for the at least one component; and representing the at least one characteristic value in a globe diagram to represent the state of the at least one component when the computer program is executed on a computer or a corresponding computing unit in an arrangement for representing a state for at least one component of a device, comprising at least one measuring unit determining at least one characteristic value for the at least one component; and at least one display unit representing the at least one characteristic value in a globe diagram representing the state of the at least one component.
